(19) United States
(12) Patent Application Publication
(10) Pub. No.: US 2011/0094483 A1
(43) Pub. Date: Apr. 28, 2011

(54) EXHAUST GAS RECIRCULATION APPARATUS

(75) Inventors: Ingee Suh, Yongin-city (KR); Myung Rae Cho, Incheon-si (KR); Kwang Sik Yang, Hwasung-si (KR); Ki Tack Lim, Incheon-si (KR); Taewon Park, Hwaseong-si (KR); Woo Tae Kim, Suwon-city (KR)

(73) Assignees: Hyundai Motor Company, Seoul (KR); Kia Motors Corporation, Seoul (KR)

(21) Appl. No.: 12/901,024

(22) Filed: Oct. 8, 2010

(30) Foreign Application Priority Data
Oct. 28, 2009 (KR) 10-2009-0102926

(51) Int. Cl. F02M 25/07

(52) U.S. Cl. 123/568.12

(57) ABSTRACT

An exhaust heat recirculation apparatus is capable of improving fuel mileage by heating lubricant using exhaust heat. The exhaust gas recirculation apparatus has a heat exchanger that is mounted at an exhaust line of an engine for heating coolant using the exhaust gas. The exhaust gas recirculation apparatus may include a main line allowing exhaust gas exhausted from each cylinder of the engine to communicate to a exhaust gas inlet, a bypass line communicated to a downstream side of the main line, a bypass valve mounted inside the bypass line, and a heat exchanger selectively communicated to the bypass line by way of the bypass valve.

### CROSS-REFERENCE TO RELATED APPLICATION

This application claims priority to and the benefit of Korean Patent Application No. 10-2009-0102926 filed in the Korean Intellectual Property Office on Oct. 28, 2009, the entire contents of which application is incorporated herein for all purposes by this reference.

### BACKGROUND OF THE INVENTION

1. Field of the Invention

The present invention relates to an exhaust heat recirculation apparatus, and more particularly to an exhaust heat recirculation apparatus that is capable of improving fuel mileage by heating a lubricant using exhaust heat.

2. Description of the Related Art

Generally, because the temperature of a lubricant cannot quickly reach an appropriate temperature at start-up of an engine, friction loss occurs at each a friction surface of the engine, and thereby fuel mileage is deteriorated by the friction loss and noxious materials are exhausted to atmosphere.

To solve the problem, an apparatus heating the lubricant using an electric heater mounted at the lubricant while being submerged therein is well known to a person skilled in the art, however, the apparatus has drawbacks of discharging a battery mounted interior or exterior to a vehicle, and a battery having a greater capacity is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention has been made in an effort to provide an exhaust gas recirculation apparatus having advantages of improving fuel mileage at a low speed, i.e., at an early stage of running an engine, by performing heat exchange between oil and exhaust gas so as to maintain high-temperature oil of the engine.

The exhaust gas recirculation apparatus having a heat exchanger that is mounted at an exhaust line of an engine for heating coolant by the exhaust gas, may include a main line inducing exhaust gas exhausted from each cylinder of the engine to communicate to an exhaust gas inlet, a bypass line communicated to a downstream side of the main line, a bypass valve mounted inside the bypass line, and a heat exchanger selectively communicated to the bypass line by the bypass valve.

The heat exchanger may further include an oil circulation passage disposed therein in a serpentine shape.

Further, one end of the bypass line may communicate with the main line, an exhaust port is formed at the other end thereof, and the exhaust gas is selectively supplied to the exhaust port or the heat exchanger by the bypass valve.

Further, the bypass valve may be one of a butterfly valve or a valve of a hinge type.

Further, the bypass valve may be controlled by a back pressure actuator using back pressure of an engine, or a solenoid valve.

Further, a fixing bracket may further be formed at one end of the bypass line.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary exhaust heat recirculation apparatus applied to an engine according to the present invention.

FIG. 2 is a perspective view of the exemplary exhaust heat recirculation apparatus of FIG. 1 according to the present invention.

FIG. 3 is a perspective view of inside portion of the exemplary exhaust heat recirculation apparatus of FIG. 1 according to the present invention.

FIG. 4 is a schematic view of an operation state of the exemplary exhaust heat recirculation apparatus of FIG. 1 according to the present invention.

FIG. 5 is a schematic view of an operation state of an exemplary exhaust heat recirculation apparatus according to the present invention.

FIG. 6 is a schematic view of an operation state of an exemplary exhaust heat recirculation apparatus according to the present invention.

FIG. 7 is a schematic view of an operation state of an exemplary exhaust heat recirculation apparatus according to the present invention.

FIG. 8 is a schematic view of an operation state of an exemplary exhaust heat recirculation apparatus according to the present invention.

FIG. 9 is a schematic view of an operation state of an exemplary exhaust heat recirculation apparatus according to the present invention.

FIG. 10 is a schematic view of an operation state of an exemplary exhaust heat recirculation apparatus according to the present invention.

FIG. 11 is a schematic view of an operation state of an exemplary exhaust heat recirculation apparatus according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

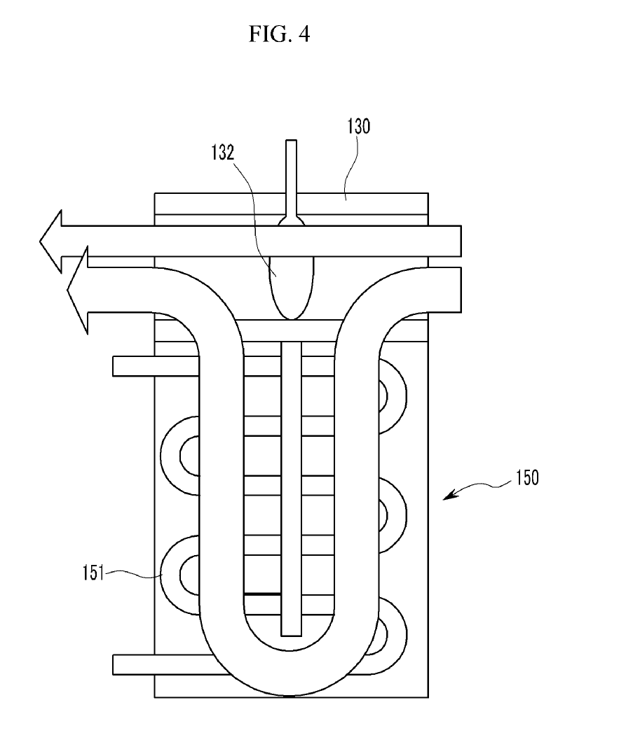

As shown in FIG. 4, an exhaust heat return apparatus 100 according to various embodiments of the present invention is mounted at an engine 10, and is communicated with an exhaust manifold (not shown) of the engine separately provided through an oil circulation passage 151.

Herein, the engine may be employed in a conventional manner, and the structures are not shown. The engine will be described schematically as follows.

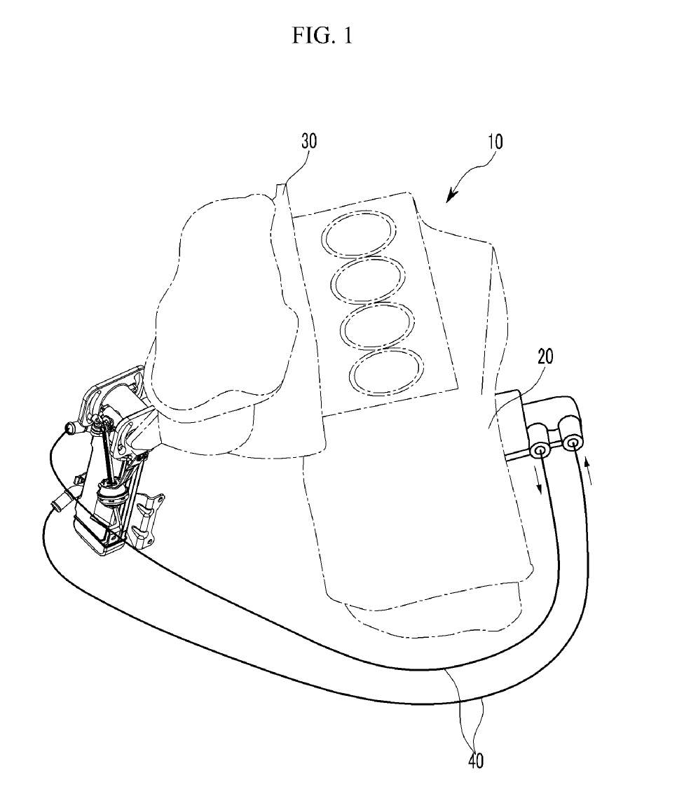

As shown in FIG. 1, the engine 10 includes a cylinder block 20, a cylinder head 30, an ignition plug (not shown) mounted at the cylinder head 30, a piston (not shown) slidably mounted inside the cylinder block 20, a connecting rod (not shown) of which one end thereof is connected to the piston through a pin (not shown), a crankshaft (not shown) engaged with the other end of the connecting rod, a combustion chamber (not shown) defined by the cylinder head 30 and the cylinder block 20, an intake pipe communicated with the combustion chamber by an intake valve (not shown), an exhaust pipe communicated with the combustion chamber by an exhaust valve, a lubricant passage circulating lubricant in the engine, and an oil pump mounted at the middle of the lubricant passage.

Therefore, the lubricant passage supplies oil to a friction surface of the engine, a connecting portion of the piston and the connecting rod, and a connecting portion of the connecting rod and the crankshaft for lubricating.

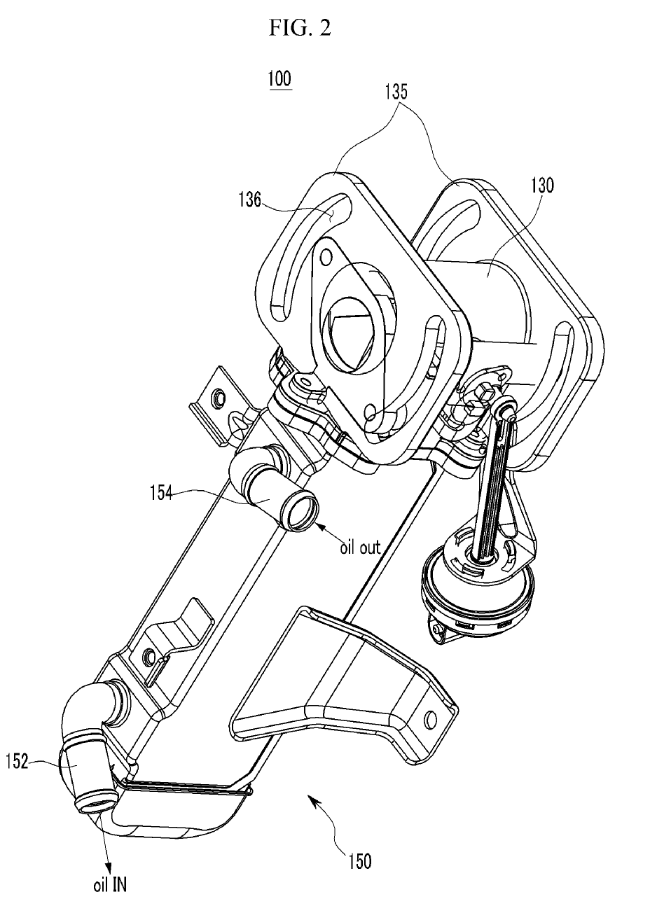

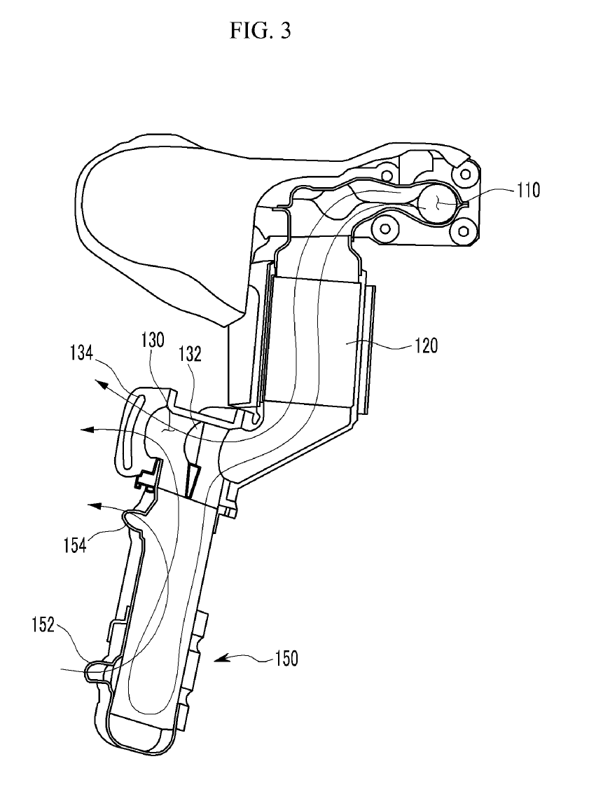

As shown in FIG. 2 and FIG. 3, the exhaust heat return apparatus includes a main line 120 having an exhaust gas inlet 110, a bypass line 130 communicated with downstream of the main line 120, and a heat exchanger 150. One will appreciate that the line may be in the form of a tubular member or pipe.

The exhaust gas inlet 110 is formed so that exhaust gas exhausted from the exhaust manifold of the engine flows into the main line 120.

Therefore, the exhaust gas generated from the engine flows into the exhaust gas inlet 110.

The exhaust gas having flowed through the exhaust gas inlet 110 flows into the main line 120.

Subsequently, the exhaust gas passes a bypass line 130 communicated with a downstream of the main line 130, and is exhausted to atmosphere through an exhaust gas outlet 134 disposed downstream of the bypass line 130.

Further, the heat exchanger 150 is provided to one end of the bypass line 130 so as to communicate therewith.

A bypass valve 132 is mounted at a middle portion of the bypass line 130, and the bypass valve 132 is selectively opened.

Thus, the exhaust gas is exhausted toward the exterior through the exhaust gas outlet 134 via the bypass line 130 when the bypass valve 132 is opened, but the exhaust gas is exhausted through the exhaust gas outlet 134 after it is diverted toward the heat exchanger 150 when the bypass valve 132 is closed.

Further, as shown in FIG. 2, a fixing bracket 135 can be mounted at both sides of the bypass line 130.

The fixing bracket 135 is provided to the heat exchanger 150 by bolting etc. in order to easier change the heat exchanger 150 in case of malfunction.

Further, because an assembling or disassembling process of the heat exchanger 150 is frequent, it is required to facilitate the process with an engaging groove 136 of the fixing bracket 135 formed as a slit shape so that adjustment of a mounting position of the heat exchanger 150 is enabled.

As shown in FIG. 4, the oil circulation passage 151 is formed inside the heat exchanger 150.

Further, an oil supply port 152 and an oil exhaust port 154 are respectively formed at the heat exchanger 150.

Therefore, the oil flows to the oil supply port 152 through an oil pipe 40, and is then exhausted through the oil exhaust port 154 via the oil circulation passage 151.

An oil pump (not shown) can be mounted at the oil circulation passage 151 in order to forcedly feed oil from an oil pan (not shown) of the engine to the heat exchanger 150, and an open/close valve (not shown) can be mounted downstream of the oil pump.

That is, the oil circulates between the oil pan and the heat exchanger 150 through the oil circulation passage 151 having an oil pump.

The oil circulation passage 151 is formed in a serpentine shape such that it is capable of efficiently exchanging heat between the inside of the heat exchanger 150 and exhaust gas passing through therein.

At this time, because flow resistance of the heat exchanger 150 is high in case of opening of the bypass valve 132, the exhaust gas directly flows through the exhaust gas outlet 134 rather than to the heat exchanger 150 so as to avoid heat exchange.

Further, in case of closing of the bypass valve 132, because all the exhaust gas flows through the heat exchanger 150, the temperature of the oil is increased due to heat exchange between the oil and the exhaust gas.

Herein, the bypass valve 132 may be a butterfly valve or a valve of a hinge type.

Further, an actuator using back pressure or a solenoid valve can be provided in order to operate the bypass valve 132.

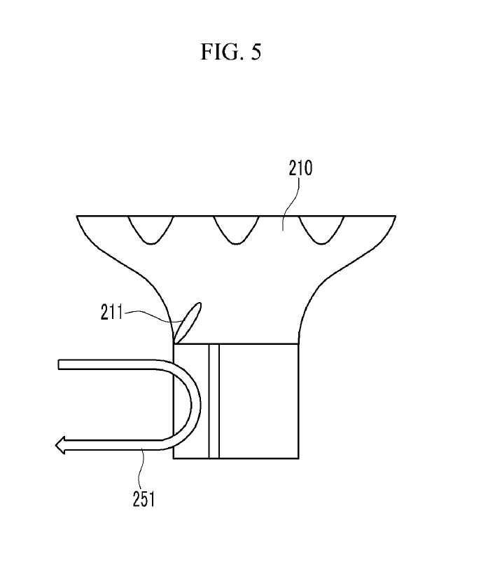

Referring to FIG. 5 to FIG. 11, an exhaust gas recirculation apparatus according to various embodiments of the present invention will hereinafter be described in detail.

At this time, among the exemplary embodiments, detailed description about similar portions with reference to various embodiments of the present invention will be omitted.

Referring to FIG. 5, an exhaust gas recirculation apparatus according to various embodiments of the present invention shows heat exchange in a process in which an oil circulation passage 251 passes through an exhaust manifold 210.

Herein, a gate valve 211 that is disposed at a front of an exhaust turbine (not shown) and that is selectively opened or closed may be provided to the exhaust manifold 210 so as to control heat exchange.

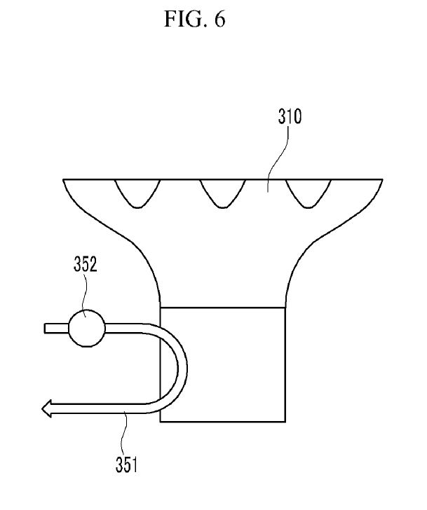

Turning to FIG. 6, an exhaust gas recirculation apparatus according to various embodiments of the present invention shows heat exchange in a process in which an oil circulation passage 351 passes through an exhaust manifold 310.

Herein, the oil flows into the oil circulation passage 351, and the oil flows according to opening or closing of an opening/closing valve 352 for controlling heat exchange.

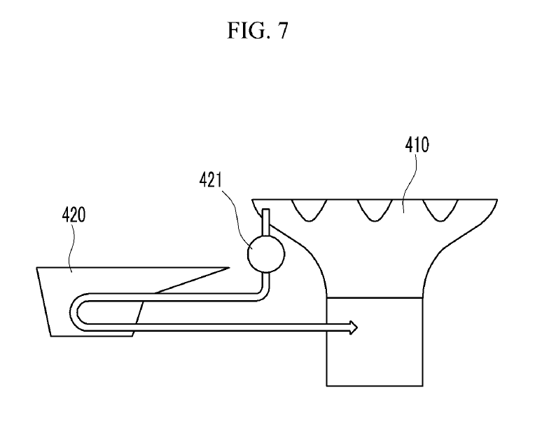

Turning to FIG. 7, an exhaust gas recirculation apparatus according to various embodiments of the present invention shows heat exchange in a process in which a portion of exhaust gas passes through an oil pan 420 of an engine from an exhaust manifold 410.

At this time, the heat exchange is controlled by using a gate valve 421 that is independently provided.

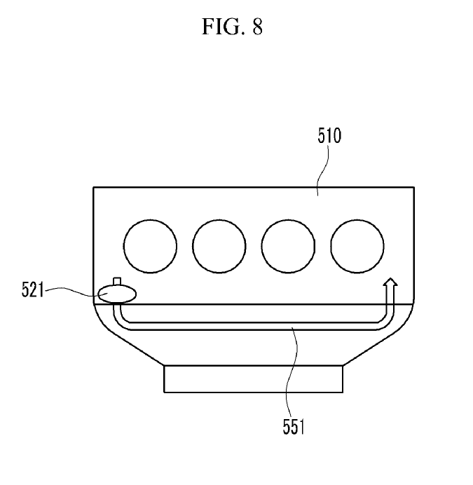

Turning to FIG. 8, an exhaust gas recirculation apparatus according to various embodiments of the present invention shows heat exchange in a process in which a portion of exhaust gas selectively passes along the inside of an oil jacket 551 that is integrally formed at an exhaust manifold 510 under control of a gate valve 521. One will appreciate that the oil jacket may be monolithically formed with the exhaust manifold.

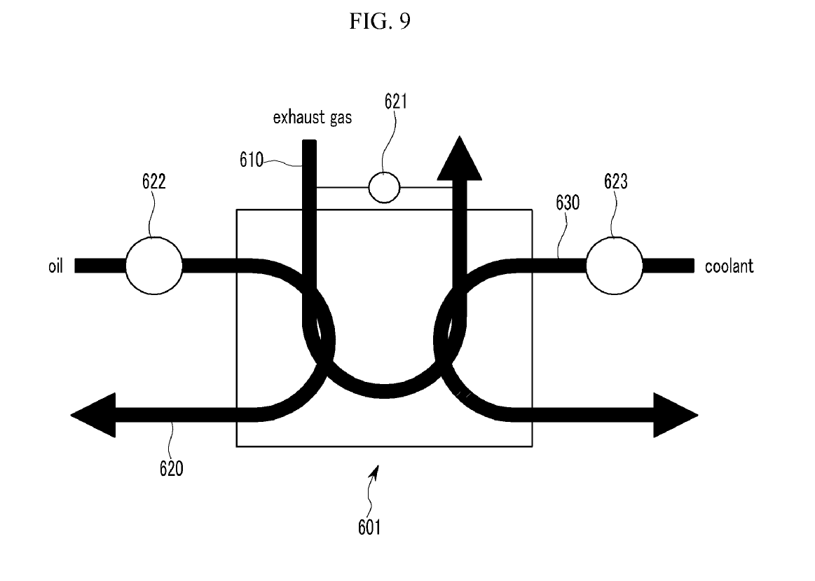

Turning to FIG. 9, an exhaust gas recirculation apparatus according to various embodiments of the present invention shows heat exchange simultaneously between oil and a coolant in a heat exchanger 601.

As shown in FIG. 9, an exhaust gas passage 610 and an oil circulation passage 620 are respectively formed inside a heat exchanger 601 so that exhaust gas and oil pass therethrough, respectively.

Further, a coolant passage 630 is formed so that it circulates nearly to the oil circulation passage 620.

That is, exhaust gas passes through the inside of the heat exchanger 601 and then the exhaust gas sequentially passes near the oil circulation passage 620 and the coolant passage 630.

At this time, first/second check valves 622 and 623 are respectively mounted in the exhaust gas passage 610, the oil circulation passage 620, and the coolant passage 630, and the heat exchange is selectively controlled according to opening or closing of the valves. At this time, a bypass valve 621 can be provided to the exhaust gas passage 610 for determining whether exhaust gas passes through the inside of the heat exchanger 601 or not.

That is, in the early stage of engine operation, the coolant and the oil quickly perform heat exchange for increasing the temperature of the coolant and the oil.

After the coolant and the oil reach predetermined temperatures, the heat exchange is stopped by using the valves 621, 622, and 623.

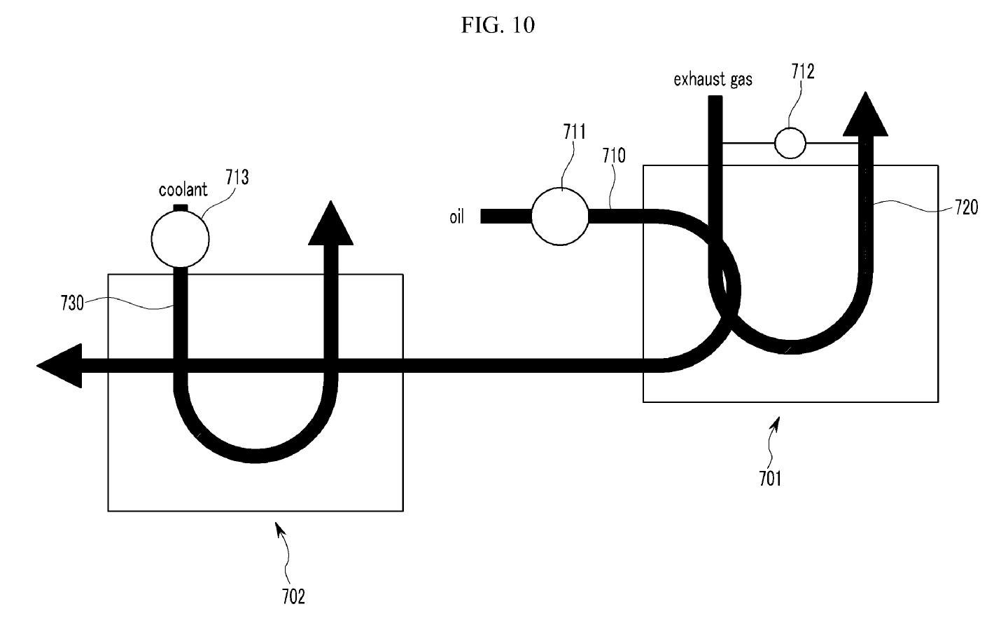

Turning to FIG. 10, an exhaust gas recirculation apparatus according to various embodiments of the present invention shows that the temperature of oil is increased or decreased by using a first heat exchanger 701 for oil circulation and a second heat exchanger 702 for coolant circulation.

As shown in FIG. 10, an oil circulation passage 710 is formed so that oil sequentially passes through the first heat exchanger 701, and the second heat exchanger 702.

Herein, an exhaust gas passage 720 is formed inside the first heat exchanger 701 for circulating the exhaust gas, and the exhaust gas passage 720 and the oil circulation passage 710 are provided for performing heat exchange therebetween.

Further, a first check valve 711 is mounted in the oil circulation passage 710 for controlling flow of the oil, and a second check valve 712 that is selectively opened or closed for controlling flow of the exhaust gas is provided to the exhaust gas passage 720. At this time, the second check valve 712 can be a bypass valve as shown in FIG. 10, so as to determine whether exhaust gas passes through the first heat exchanger 701 or not.

That is, in the early stage of engine operation, the first check valve 711 and the bypass valve 712 are opened for performing heat exchange between the oil and exhaust gas.

Even in the early stage of engine operation, if the temperature of the oil is higher than that of the coolant, the heat exchange is performed therebetween for quick warm-up.

Meanwhile, oil having passed through the first heat exchanger 701 passes through the second heat exchanger 702.

At this time, a coolant passage 730 is provided so that coolant circulates through the inside of the second heat exchanger 702.

Further, a third check valve 713 that is mounted in the coolant passage 730 is selectively opened or closed so as to control flow of the coolant.

That is, at a high speed of an engine, the first and third check valves 711 and 713 are opened so as to perform heat exchange between the oil and the coolant, and thereby the temperature of the oil is decreased.

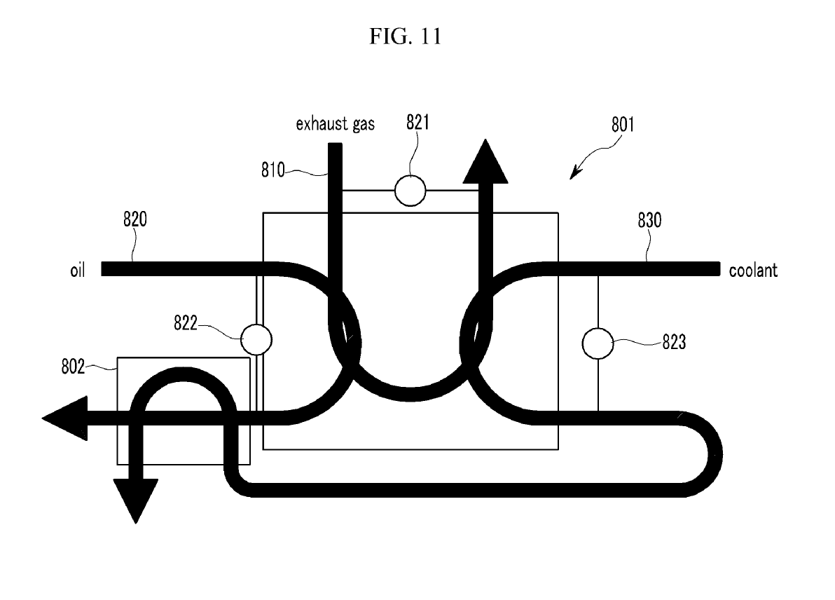

Turning to FIG. 11, an exhaust gas recirculation apparatus according to various embodiments of the present invention shows heat exchange between oil and coolant in a heat exchanger 801.

Herein, the exhaust gas recirculation apparatus according to various embodiments of the present invention, similar to the exhaust gas recirculation apparatus according to various embodiments of the present invention including that illustrated in FIG. 9, has an advantage of quickly warming up by performing heat exchange among an exhaust gas passage 810, an oil circulation passage 820, and a coolant passage 830.

Herein, in the same fashion as described above, first, second, and third bypass valves 821, 822, and 823 are respectively mounted in the exhaust gas outlet 810, oil circulation passage 820, and the coolant passage 830, and then heat exchange is performed according to opening or closing of the valves.

However, as opposed to the exhaust gas recirculation apparatus according to various embodiments of the present invention, at a high speed of an engine, the oil and the coolant are diverted to an auxiliary heat exchanger 802 so as to perform heat exchange, and thereby the coolant more quickly cools the oil.

Therefore, the exhaust gas recirculation apparatus has an advantage of improving fuel mileage at a low speed, i.e., at an early stage of running an engine, by performing heat exchange between oil and exhaust gas so as to maintain high-temperature oil of the engine, and an advantage of reducing thermal resistance at a high speed of the engine by diverting the exhaust gas from the heat exchanger.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust gas recirculation apparatus having a heat exchanger mounted on an exhaust line of an engine for heating coolant using exhaust gas, the apparatus comprising:
a main line allowing exhaust gas exhausted from each cylinder of the engine to fluidly communicate with an exhaust gas inlet;
a bypass line fluidly communicating with a downstream side of the main line;
a bypass valve mounted inside the bypass line; and
a heat exchanger selectively communicating with the bypass line by the bypass valve.

2. The apparatus of claim 1, wherein the heat exchanger further comprises an oil circulation passage disposed therein having a serpentine shape.

3. The apparatus of claim 1, wherein one end of the bypass line communicates with the main line, an exhaust port is formed at another end thereof, and the exhaust gas is selectively supplied to the exhaust port or the heat exchanger by the bypass valve.

4. The apparatus of claim 1, wherein the bypass valve is one of a butterfly valve or a hinge valve.

5. The apparatus of claim 4, wherein the bypass valve is controlled by one of a back pressure actuator using back pressure of an engine, or a solenoid valve.

6. The apparatus of claim 1, further comprising a fixing bracket formed at one end of the bypass line.

7. The apparatus of claim 2, wherein the heat exchanger further comprises:
a gate valve selectively allowing the exhaust gas to pass therethrough; and
an oil circulation passage passing through an inside of the exhaust manifold,
wherein heat exchange between oil and the exhaust gas is performed in the exhaust manifold.

8. The apparatus of claim 2, wherein the heat exchanger comprises:
an oil circulation passage passing through the inside of the exhaust manifold; and
an open/close valve that is mounted in the oil circulation passage, which open/close valve controls exhaust of oil flowing in the oil circulation passage,
wherein heat exchange between the oil and the exhaust gas is performed by the open/close valve.

9. The apparatus of claim 2, wherein the heat exchanger further comprises:
an oil circulation passage controlling a portion of exhaust gas to pass through an oil pan of the engine,
wherein the exhaust gas passes through the oil pan according to opening or closing of a gate valve mounted in the oil circulation passage.

10. The apparatus of claim 2, wherein the heat exchanger further comprises:
an oil jacket within the exhaust manifold monolithically formed with the exhaust manifold; and
an open/close valve disposed in the oil jacket,
wherein the oil flow is controlled by the open/close valve that is selectively opened or closed.

11. The apparatus of claim 2, wherein the heat exchanger further comprises:
an exhaust gas passage formed therein so that the exhaust gas circulates therein;
an oil circulation passage that passes through an inside of the heat exchanger, and that is disposed so that oil exchanges heat through the exhaust gas passage; and
a coolant passage that circulates coolant inside the heat exchanger, and that is disposed at the exhaust gas passage so that they exchange heat,
wherein first, second, and third check valves are respectively mounted in the exhaust gas passage, the oil circulation passage, and the coolant passage, and the valves open and close to exchange heat between the exhaust gas passage, the oil circulation passage, and the coolant passage.

12. The apparatus of claim 2, wherein the heat exchanger further comprises:
an oil circulation passage in which oil circulates;
an exhaust gas passage in which exhaust gas circulates;
a first heat exchanger having a space for exchanging heat between the oil circulation passage and the exhaust gas passage;
a coolant passage in which coolant circulates; and
a second heat exchanger having a space so that oil having passed from the first exchanger can exchange heat with the coolant passage,
wherein first, second, and third check valves are respectively mounted in the oil circulation passage, the coolant passage, and the exhaust gas passage, and the oil circulation passage, the coolant passage, and the exhaust gas passage exchange heat by the valves being opened or closed.

13. The apparatus of claim 2, wherein the heat exchanger further comprises:
an exhaust gas passage in which exhaust gas circulates;
an oil circulation passage that passes through the inside of the heat exchanger, and that is disposed so that oil exchanges heat through the exhaust gas passage; and
a coolant passage that circulates inside the heat exchanger, and that is disposed at the exhaust gas passage so that they exchange heat;
an auxiliary heat exchanger having a space so that heat can be exchanged upstream of the oil circulation passage and downstream of the oil circulation passage,
wherein first, second, and third check valve are respectively mounted in the oil circulation passage, the coolant passage, and the exhaust gas passage, and the valves open and close to exchange heat between the oil circulation passage, the coolant passage, and the exhaust gas passage.
